(19) United States
(12) Patent Application Publication
(10) Pub. No.: US 2006/0080644 A1
(43) Pub. Date: Apr. 13, 2006

(54) Parameterization of programming structures

(75) Inventors: Robert M. Fuhrer, New York, NY (US); Adam Kiezun, Cambridge, MA (US); Frank Tip, Ridgewood, NJ (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/960,203

(22) Filed: Oct. 7, 2004

(51) Int. Cl. G06F 9/45

(52) U.S. Cl. 717/137

(57) ABSTRACT

A method for transforming at least a portion of at least one programming structure into a type parameter includes receiving a first list of at least one declaration of at least one programming structure for transforming to a type parameter. The method further includes generating a second list of at least one declaration of the at least one programming structure that must be transformed into a type parameter if the at least one declaration of the first list is transformed to a type parameter. The method further includes generating a third list of at least one declaration of the at least one programming structure that may optionally be transformed into a type parameter and receiving a selection of zero or more declarations from the second list and zero or more declarations from the third list.

### STATEMENT REGARDING FEDERALLY SPONSORED-RESEARCH OR DEVELOPMENT

This invention was made with Government support under NBCH30390004 awarded by PERCS II. The Government has certain rights in this invention.

### CROSS-REFERENCE TO RELATED APPLICATIONS

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of computer programming and more particularly relates to the field of generic programming structures such as Java classes.

### BACKGROUND OF THE INVENTION

In object-oriented programming, a class is a category of objects. Classes describe both the properties and behaviors of objects. Properties contain the data that are exposed by the class. Behaviors are the functionality of the object, and are defined by the methods (also called member functions) the class. Collectively, the public properties and methods of a class are known as the object interface. Classes themselves are not objects, but instead they are used to instantiate (i.e., create) objects in memory. Java is a high-level object-oriented programming language. The Java programming language is simplified to eliminate language features that cause common programming errors.

A generic Java class is a class that has been abstracted in order to be compatible with varied types. The latest version of the Java language, Java 1.5, provides additional support for producing generic Java classes. A generic class takes one or more type parameters, which are placeholders for as-yet unspecified types used within the class definition. Clients must supply a specific type for each type parameter when using such a generic type. This permits the generic class to interoperate with a set of types that may not be related by inheritance, often without the loss of any type information. This typically greatly reduces or even eliminates the need for type-casts.

Consider, for example, a generic container class Cell<T> with the single type parameter T:

```
class Cell<T> {
    private T item;
      public Cell(T t) { item= t; }
      T getItem( ) { return item; }
      void setItem(T t) { item= t; }
  }
```

Observe that T can be used within the definition of Cell in most of the ways an ordinary type can, the most notable exception being that a type parameter cannot be instantiated (i.e., “new T( )” is not allowed). Clients must supply a specific (though not necessarily concrete) type when instantiating the class or declaring variables of that type:

```
class CellClient {
  void foo( ) {
    Cell<String> cs= new Cell<String>(“abc”);
    String s= cs.getItem( );
  }
}
```

A common alternative to parameterization in the absence of proper language support (and the way much Java code was written before the release of Java 1.5) is to define Cell using Object in all places where the type parameter would have appeared:

```
class Cell {
    private Object item;
    public Cell(Object t) { item= t; }
    Object getItem( ) { return item; }
    void setItem(Object t) { item= t; }
  }
```

With this approach, clients must down-cast the return value of Cell.getItem( ) when retrieving the Cell's contents:

```
class Client {
  void foo( ) {
    Cell cs= new Cell(“abc”);
    String s= (String) cs.getItem( );
  }
}
```

Note that such an approach preserves none of the type information available on the client side, leaving type safety to the client code at run-time. Of course, clients can be mistaken about the type of a Cell's contents, causing ClassCastExceptions when attempting to down-cast getItem( )'s return value. This is clearly undesirable.

Another common alternative to parameterization is to define one or more variants of Cell, each bound to some specific type, e.g.:

```
class StringCell {
  private String item;
  public Cell(String s) { item= s; }
  String getItem( ) { return item; }
  void setItem(String s) { item= s; }
}
```

Clients do not need to down-cast the return value of StringCell.getItem( ), but have lost the ability to use this class with anything but Strings.

The Java language further supports the use of type bounds. A type parameter may be given an upper bound, i.e., a type from which all actual type arguments must derive, as in:

```
class Coordinate<T extends Number> {
  private T x, y;
  public T getX( ) { return x; }
  public T getY( ) { return y; }
}
```

In this case, the usages Coordinate<Integer> and Coordinate<Float> are legal, but Coordinate<File> is not. Without such a constraint, the only operations defined on type parameter T, and therefore on the fields x and y, are those provided by Object (the default bound).

A method may be given its own type parameter, as in:

class Foo {
<T> void reverse(List<T> list) { /*...*/ }
}

Here, each call to reverse( ) implicitly supplies a type for the type parameter T by the type of the actual parameter. That is, the compiler will infer the type of T from the actual method argument.

The Java language further supports the use of wildcards. If a method argument is of a parametric type, and the type parameter itself is not directly used in the method, the type parameter need not be named. Such a type parameter is called a “wildcard.” Wildcards, like named type parameters, can be given bounds, as seen in the method Collection.addAll( ) from an Application Programming Interface (API) of Java 1.5:

interface Collection<T> {
void addAll(Collection<? extends T> c);
}

Note that this definition permits greater flexibility than the alternative, perhaps naive, definition:

interface Collection<T> {
void addAll(Collection<T> c);
}

In this version, only a Collection of the exact same element type may be passed to addAll( ). This is unnecessarily restrictive, since the receiving Collection can of course accommodate elements that are more specific than (i.e., subtypes of) T.

It should be noted that the presence of an upper bound on the wildcard in the definition of the given Collection c prevents the addition of elements to c, since one cannot be certain that the element type of the Collection to which c refers is compatible with any particular sub-type of T. For example, where the receiving Collection is a Collection<Number>, c could be either a Collection<Integer> or Collection<Float>, so we cannot safely add Integer's or Float's to c. On the other hand, one can be certain that any element retrieved from Collection c is in fact at least a T.

Unlike named type parameters, wildcards can be given lower bounds as well, as shown in this example, taken from the Java Development Kit (JDK) that accompanies Java 1.5:

```
public class Collections {
    public static <T> void fill(List<? super T> list, T obj) { /*...*/ }
}
interface Collection<T> {
  void addTo(Collection<? super T> c);
}
```

There is a constraint on lower-bounded wildcards, symmetric to the above constraint on upper-bounded wildcards. Namely, the presence of the lower bound T on the wildcard in the definition of argument ‘list’ prevents the retrieval of elements from list, since one cannot be certain that the element type of the List to which list refers is compatible with any particular super-type of T. For example, when the second argument obj is a Float, list could be a List<Number> or List<Comparable>, so one cannot safely retrieve Float's from list. On the other hand, one can be certain that any actual argument for list is capable of holding at least a Float, so we can safely store Floats or anything more specific. A more complete treatment of syntax and semantics of Java 1.5 generics, refer to the publication “The Java Language Specification” by Gosling, Joy, Steele and Bracha.

In sum, parameterization of a Java class allows for a more generic Java class in terms of types. Thus, given a Java class including a set of type references, selective parameterization of the Java class includes the selecting of certain types in the class and transforming the selected types into type parameters such that the behavior of the class remains intact. Parameterization of the Java class, however, includes various degrees of freedom, such as the location of a type variable, the manner in which to name a type variable and whether to transform certain types in the class into type parameters (other than the ones that must be transformed).

As seen above, generic classes (those having type parameters) tend to be usable in many more contexts than their concrete counterparts. Moreover, type safety can be better guaranteed by checks performed at compile time, rather than type-casts at run-time. As a result, the process of parameterization, or introducing type parameters into concrete classes, is an effective means of increasing the potential for code reuse.

However, because client code must explicitly identify each actual type parameter, this also tends to increase the complexity of the usage somewhat. Thus, one must take care to balance the trade-off between complexity of use and reuse. It is for this reason that hard-wired parameterization mechanisms tend to be less useful than those that offer the developer the control over these software engineering trade-offs.

Therefore, there is a need to overcome problems with the prior art as discussed above, and more particularly a need to automate the process of transforming elements of a Java class into type parameters.

### SUMMARY OF THE INVENTION

Briefly, according to an embodiment of the invention, a method for transforming at least a portion of at least one programming structure into a type parameter includes receiving a first list of at least one declaration of at least one programming structure for transforming to a type parameter. The method further includes generating a second list of at least one declaration of the at least one programming structure that must be transformed into a type parameter if the at least one declaration of the first list is transformed to a type parameter. The method further includes generating a third list of at least one declaration of the at least one programming structure that may optionally be transformed into a type parameter and receiving a selection of zero or more declarations from the second list and zero or more declarations from the third list.

In another embodiment of the present invention, an information processing system for transforming at least a portion of at least one programming structure into a type parameter is disclosed. The information processing system includes a receiver for receiving a first list of at least one declaration of at least one programming structure for transforming to a type parameter. The information processing system further includes a processor configured for generating a second list of at least one declaration of the at least one programming structure that must be transformed into a type parameter if the at least one declaration of the first list is transformed to a type parameter and generating a third list of at least one declaration of the at least one programming structure that may optionally be transformed into a type parameter. The information processing system further includes an interface for receiving a selection of zero or more declarations from the second list and zero or more declarations from the third list.

In another embodiment of the invention, a computer readable medium including computer instructions for transforming at least a portion of at least one programming structure into a type parameter includes instructions for receiving a first list of at least one declaration of at least one programming structure for transforming to a type parameter. The computer readable medium further includes computer instructions for generating a second list of at least one declaration of the at least one programming structure that must be transformed into a type parameter if the at least one declaration of the first list is transformed to a type parameter. The computer readable medium further includes computer instructions for generating a third list of at least one declaration of the at least one programming structure that may optionally be transformed into a type parameter and receiving a selection of zero or more declarations from the second list and zero or more declarations from the third list.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a code listing shown for exemplary purposes.

FIGS. 2A-2F are code listing showing the code listing of FIG. 1 is varying stages of transformation.

FIG. 3 is a block diagram depicting the control flow of the parameterization process, according to an embodiment of the invention.

FIG. 4 is a table showing the grammar used for describing type constraints.

FIGS. 5-8 depict rules used to generate type constraints.

FIGS. 9-19 depict exemplary type constraints in varying stages of development.

FIG. 20 is a table depicting additional rules used to generate type constraints.

FIG. 21 is a set of equations used for the invariant subtyping of parametric types.

FIGS. 22-26 depict exemplary type constraints.

FIG. 27 is a high level block diagram showing an information processing system useful for implementing one embodiment of the present invention.

### DETAILED DESCRIPTION

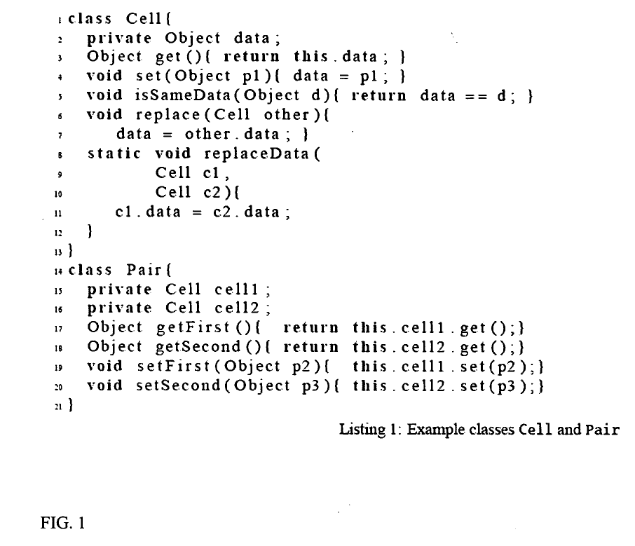

FIG. 1 shows an example class Cell, which is a container that can store a single value, and class Pair, which can store two values (of possibly different types). Class Pair is implemented in terms of Cell. The Cell class provides standard accessor methods, get and set. The aforementioned example will be used to illustrate the many degrees of freedom that are available when parameterizing classes. In general, the software engineering trade-offs are complex, so that there is no unique “best” solution. A partial list of the available degrees of freedom includes: 1) the type references that should (for reusability, modifiability, etc.) become references to type parameters (which subsumes the decision as to which classes to parameterize), 2) for a given type reference to be transformed to a reference to a type parameter, whether to “reuse” an existing type parameter or to create a new one, 3) whether to leave references raw or parameterize the references using type bounds, if any, corresponding to each type parameter, 4) whether to declare a given type parameter in a method or in a class, 5) whether to name a given type parameter (i.e. whether it should be a wildcard), 6) whether to add casts at creation or access times, in the case of arrays, and 7) whether to declare a given type parameter in the innermost enclosing class or one of its enclosing classes.

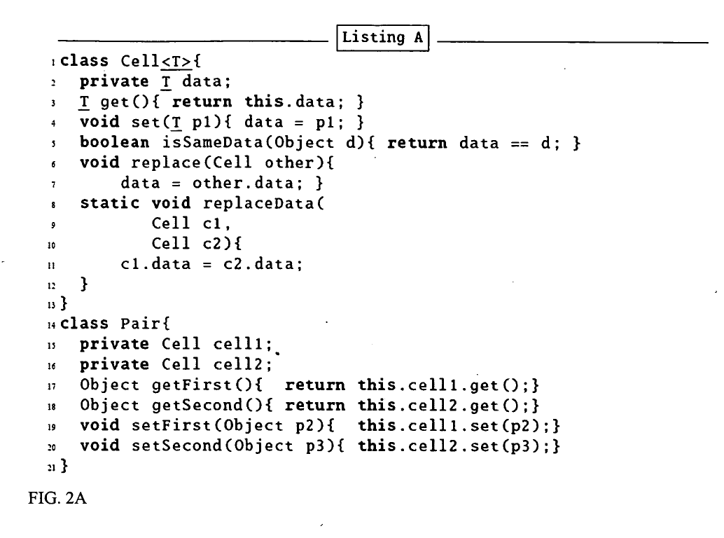

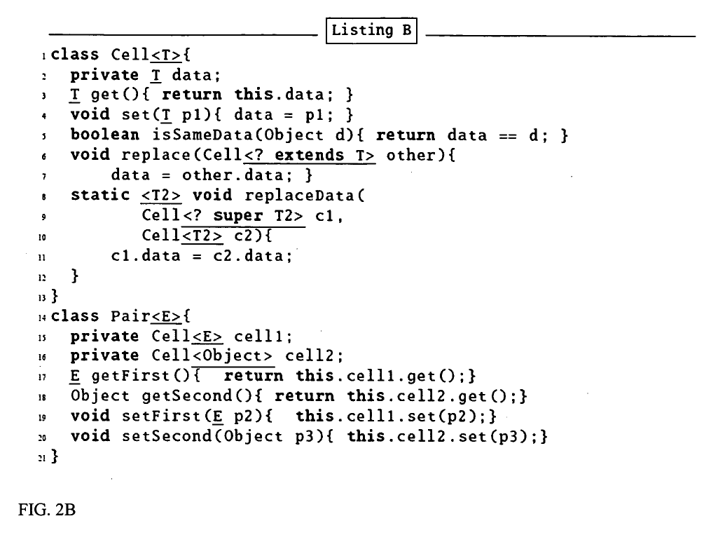

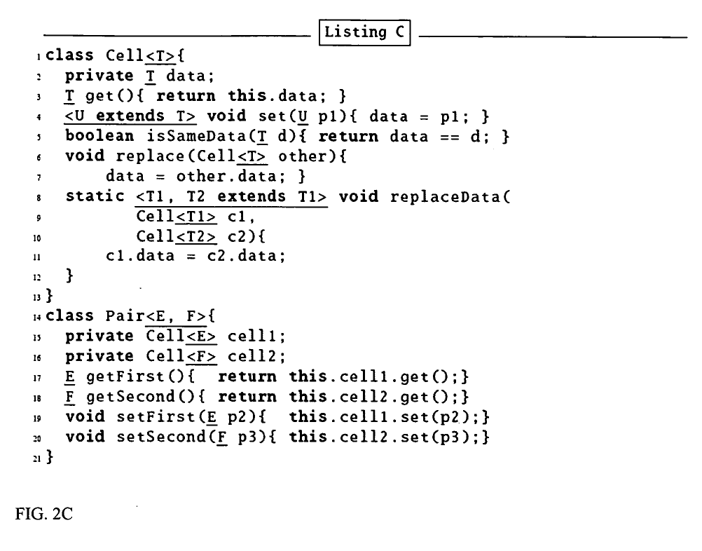

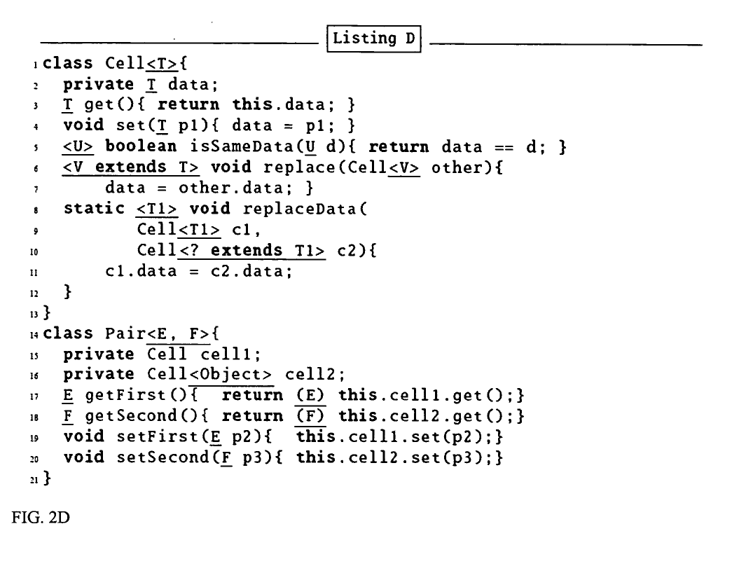

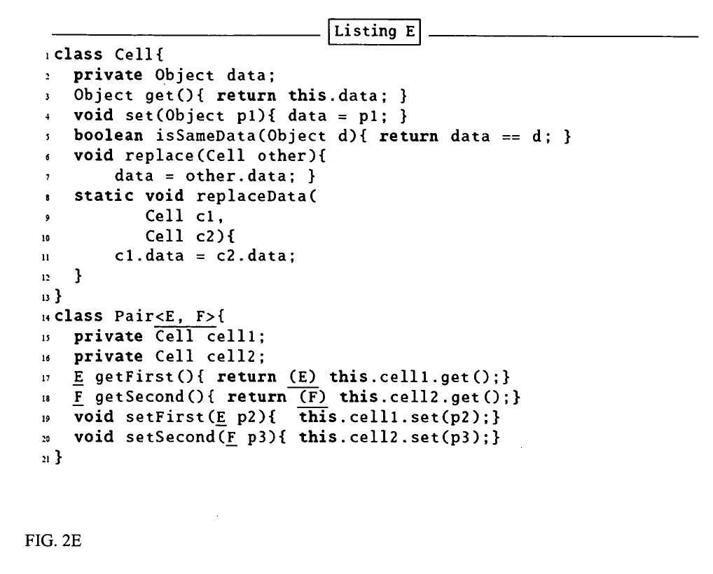

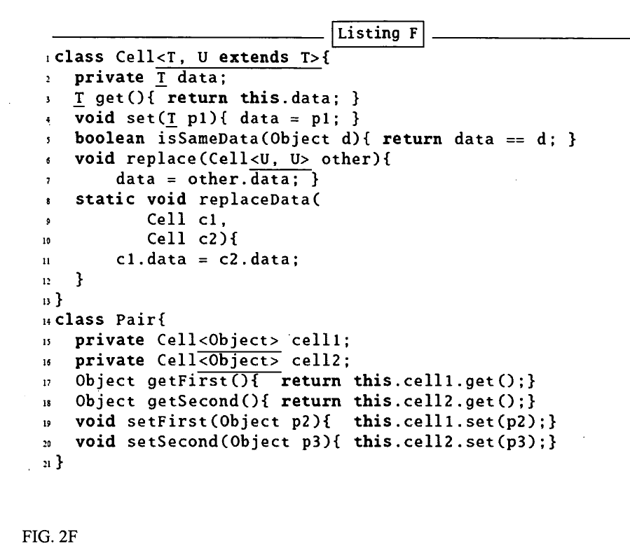

The decision as to which classes to parameterize is non-trivial. It may depend on the overall design of the program and on programmer's intentions. However, even after the classes to parameterize have been decided upon, there are still many possible ways to do so. Consider the classes in FIG. 1. It could be decided to parameterize only the Cell class (as shown in Listing A in FIG. 2A), to parameterize only the Pair class (as show in Listing E in FIG. 2C), or we could decide to parameterize both classes (as shown in other listings of FIGS. 2A-2C). Within the context of one class, there may also be multiple ways to parameterize.

Listing B in FIG. 2B is an example in which the class Pair is given only a single type parameter (i.e. it is, so to speak, parameterized half-way). Depending on the program's design and programmer's intentions, any of these parameterizations may be desired.

Line 5 in the listing of FIG. 1 illustrates another interesting point. If class Cell is parameterized as Cell<T>, the type of the parameter of method sameData may be left as Object or changed into T (as shown in Listing A of FIG. 2A and Listing C in FIG. 2B). Again, the variant to choose is a design decision. Retaining the type Object is necessary in order to allow invoking sameData with an argument of any kind, while T will allow only the type T and its subtypes. Since an object of no type other than T or one of its subtypes will ever be identical to the object stored in the data field, changing the parameter type to T would effectively help statically discover cases when sameData always returns false. In many cases such a check is desirable but when classes must be backward compatible, it is not. This is why the designers of the standard Java collections decided, when parameterizing code, to leave the parameter types of several methods as Object. Examples include method contains(Object) in interface List<T>, method get(Object) in interface Map<K, V>, etc.

The parameterizations described above do not show the full spectrum of possibilities. Consider the Cell class. It is easy to verify that, if one turns the return type of the get method into a type parameter, then both the type of the data field and the type of the parameter p1 must also become type parameters. (More precisely, they must become type parameters if casts are not introduced. A variant with casts for the Cell class is not illustrated, but Listing E in FIG. 2E shows a similar situation for the Pair class.) In Listing A in FIG. 2A, the same type parameter was chosen for all three type references. It need not be so. One, two or three different type parameters (sub-typing relationships between them expressed by bounds) can be used. Listing F in FIG. 2F shows the parameterization with two distinct type parameters.

Existing references to newly parameterized classes may be retained “as are” (i.e., as raw references) or instantiated with types or type parameters. As an example, consider the declaration in line 15 in the listing of FIG. 1. When the Cell class is parameterized as Cell<T>, that reference can be retained as Cell (as in Listing D in FIG. 2D), instantiated at erasure of bounds as Cell<Object> (as in Listing F in FIG. 2F) or, if Pair is also parameterized, instantiated with a type parameter Cell<E> (as in Listing C in FIG. 2C). The use of raw types is potentially unsafe because all generic information is lost but it can be more convenient as syntactically simpler. In the case under consideration, the parametric declaration Cell<Object> offers little, if any, advantage over the simpler raw Cell.

Instantiating a parametric type using the type parameters' bounds is, however, not always possible. The erasure of bounds might itself be out of bounds as the following class shows:
class ComparableCell<T extends Comparable<T>>{ . . . }

Instantiating ComparableCell at the erasure of bounds, i.e. ComparableCell<Comparable> is disallowed by the compiler because Comparable is not a subtype of Comparable<Comparable> as required by the bound on the type parameter T. In cases such as this, the type reference may have to remain raw. It is also the case when a bound on a type parameter is not realizable as in the class below (class String is final and does not implement the interface java.util.List so the bound can never be realized).
class NotDoableCell<T extends String & List<T>>{ . . . }

Turning to the replaceData method in class Cell in the listing of FIG. 1, the class takes as parameters two cell objects and replaces the data stored in one by the data stored in the other. The types of the cells are therefore related. The method is static so in order to parameterize it, it must be enhanced with its own type parameters and the relations between them must be expressed, as shown in Listing C in FIG. 2C.

Method replace of the listing of FIG. 1 is similar but it shows more flexibility in parameterization. It takes as the parameter a cell and replaces the data stored in the receiving object by the data stored in the parameter cell. The parameter of the method requires a type argument. The method is not static, so there are two options. Either give the type parameter to the method itself, thus making it a generic method or add the type parameter to the class itself. The two options are illustrated by Listings D and F in FIGS. 2D and 2F, respectively.

Wildcards introduce additional degrees of freedom to the parameterization problem. Consider the replaceData method. Rather than specifying two named type parameters, we choose to make one of them unnamed (i.e. a wildcard). Because wildcards can be bounded either from below or from above, there are two equivalent parameterizations, shown in Listings B and D in FIGS. 2B and 2D, respectively. The parameter of the replace method can also be a wildcard, as shown in Listing B.

Using wildcards versus named type parameters is to some extent a question of preference. Some programmers might prefer having fewer type parameter names to consider while some might find wildcards confusing and prefer to have explicit names for type parameters. There are, however, more important differences between named and unnamed type parameters. First, wildcards can have either lower or upper bounds. Lower-bounded wildcards offer only get-like functionality while upper-bounded ones offer only set-like functionality. Named type parameters can only have upper bounds. As a result, a wildcard can sometimes be used where a named type parameter cannot be used and vice-versa. Second, wildcards can be used in types of fields, while using a named type parameter would require parameterizing the containing class. For example, a field that can store any kind of List can be type-safely declared as List<?> (as long as the list is accessed in a read-only fashion). This is because using a raw type is also possible but not type-safe.

The presence of arrays creates further degrees of freedom. Consider the following code that models a java.util.Vector-like class:

```
class SimpleVector{
  private Object[ ] a = new Object[10];
  Object get(int i){ return a[i];}
  void set(Object o, int i){ a[i] = o;}
  ...
}
```

In Java 1.5, one cannot create generic arrays (i.e., an expression “new T[10]” is disallowed), so the “obvious” parameterization is not allowed by the language. There are two possible approaches to solving this problem: 1) allocate the array as before, cast to T[ ] right away and parameterize by T everywhere else (shown in the first of the next two listings) and 2) leave the declaration of a intact and cast to T on reads from the array (shown in the second of the next two listings). Interestingly, both approaches are realized in the standard libraries—by classes java.util.ArrayList and java.util.Vector, respectively.

```
class SimpleVector<T>{
  private T[ ] a = (T[ ])new Object[10];
  T get(int i){ return a[i];}
  void set(T o, int i){ a[i] = o;}
  ...
}
class SimpleVector<T>{
  private Object[ ] a = new Object[10];
  T get(int i){ return (T) a[i];}
  void set(T o, int i){ a[i] = o;}
  ...
}
```

In the previous sections it was shown that, for a given Java program, many different parameterizations are possible. Thus, there is no one best solution to the parameterization problem. The multitude of degrees of freedom is inherent and decisions can depend on the program's overall design or even, to some extent, on the programmer's personal preferences. The present invention exposes the universe of solutions to the programmers, rather than, by using heuristics, limiting the programmer to one or only a few solutions.

The present invention provides an automated tool to assist in parameterization of Java classes. The present invention supports wildcard discovery, as discussed above, and a source-to-source implementation. The present invention provides an improvement over heuristics in that the universe of solutions is presented to the programmer by allowing for many parameterizations to be valid solutions to the constraint system. In one embodiment of the present invention, a Graphical User Interface is provided for allowing a user or programmer to interact with the parameterization process.

The present invention provides for a sound translation of a Java class. The parameterized program type checks after conversion and, at run-time, it throws exactly the same exceptions (if any) as the original program. The present invention further provides for behavior preservation of the Java class. The translation preserves the program's run-time behavior in all contexts. Additionally, in order for the tool of the present invention to be universally usable, it does not depend on a specific Java Virtual Machine (JVM), operating system or compiler. In order to ensure greater availability of the tool, it can be integrated into a programming environment, as stand-alone software engineering tools are typically more difficult to use for many programmers.

The present invention further provides for flexibility. In general, there are many solutions to a parameterization problem. The tool of the present invention allows the user to find and try various solutions in an exploratory manner. It is assumed that the original Java program being transformed is type-correct (i.e., conforms to Java typing rules).

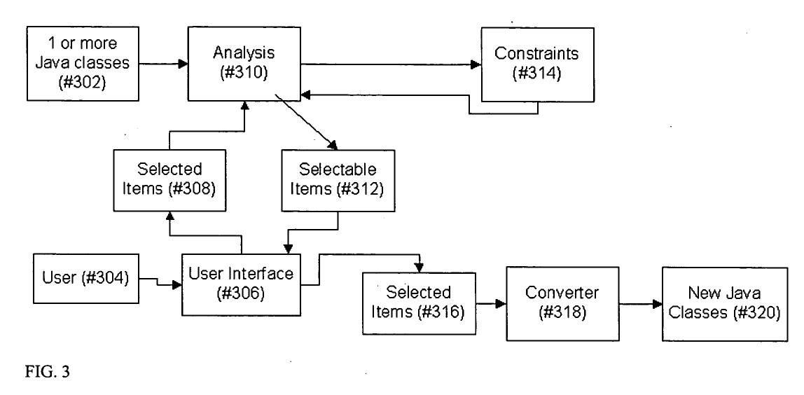

FIG. 3 is a block diagram depicting the control flow of the parameterization process, according to an embodiment of the invention. The block diagram of FIG. 3 shows the method in which one or more Java classes is parameterized. The method of FIG. 3 begins with one or more Java classes 302. Note that although FIG. 3 depicts the transformation of a Java class, the present invention more generally applies to the transformation of programming structures such as a C++ class, an ML programming language class-like element, a Haskell programming language class-like element. The present invention more generally applies to any other class-like element defined by a programming language that supports type parameters and a useful and common form of parametric polymorphism. We illustrate the concepts throughout the Java 1.5 language as an exemplar of such a language, through the techniques described herein are applicable to any language supporting type parameters.

A user 304 interacts with a GUI 306 or other type of interface to indicate to the present invention which items, or declarations, of the one or more Java classes the user 304 desires to have transformed into type parameters. A declaration can be a method parameter, a method return type, a local variable or a field. The user 304 can makes selections from a list of declarations in the interface 306. Ultimately, a list of selections 308 is produced by the interface 306.

In one embodiment of the present invention, the selected items 308 are not produced by a user 304 interacting with an interface 306. Rather, the selected items 308 are produced by another entity such as a computer, a program, a computer readable medium or any other non-human independent entity. The selected items 308 can include, for example, a set of pairs including a declaration to be rewritten and the type parameter to which the declaration should be rewritten. For example, when one type parameter is bounded by another, as when the type constraints dictate that T₂<=T₁, one can choose to substitute T₁ for T₂ everywhere (since by definition T₁<=T₁). This results in the use of one less type parameter, which enhances simplicity.

The one or more Java class 302, as well as the list of selections 308 produced by the interface 306, is read by an analysis module 310 of the present invention. The analysis module 310 analyzes the one or more Java class and produces a list of constraints 314 that is utilized to produce a list of selectable items 312. The selectable items 312 include: 1) a list of declarations that must be transformed into type parameters as a result of the declarations chosen for transformation in 308, and 2) a list of declarations that optionally may be transformed into type parameters. The method in which the analysis module 310 analyzes the one or more Java classes and produces a list of constraints 314 and the list of selectable items 312 is discussed in greater detail below.

The user 304 again interacts with the GUI 306 or other type of interface to indicate to the present invention which items, or declarations, of the one or more Java classes in the list of selectable items 312 the user 304 desires to have transformed into type parameters. Note that the user may only choose from the list of declarations that optionally may be transformed into type parameters—that is, the user 304 may not choose from the list of declarations that must be transformed into type parameters as a result of the declarations chosen for transformation in 308 (see the above description of selectable items 312).

The user 304 may also provide other data via the GUI 306, such as the names of type parameters and the locations of type parameters. The location of a type parameter refers to the decision as to whether to place a type parameter on a method (if applicable) or on a class, and if a class is chosen, whether to place the type parameter on the. innermost enclosing class or one of it enclosing classes. The aforementioned decisions regarding the location of a type parameters are discussed in greater detail by way of example below. Further, the user 304 can specify via the GUI 306 additional information type parameters. For classes for which more than on type parameter is introduced, the user 304 may control the order in which the type parameters appear in the transformed classes' declarations. The user 304 may exercise this control by specifying the desired order via the GUI 306.

The user 304 can make selections from a list of declarations in the interface 306 and enter data into text fields or other interface elements. Ultimately, a list of selections 316 is produced by the interface 306. Some decisions need not be made by the user 304 but can be default decisions made by the tool of the present invention. For example, a default decision may be that type parameters are left unnamed (such as wildcards) or that, in the absence of other indicators, fewer type parameters are created for a given class or method (this would not be the case only if the smaller number of type parameters can limit the ways in which the class can be meaningfully used).

Next, the list of selections 316 produced by the interface 306, is read by a converter module 318 of the present invention. The converter module 318 analyzes the Java class and transforms the declarations of list 308 and list 316 into type parameters. The list of selections 316 can include, for example, a set of pairs including a declaration to be rewritten and the type parameter to which the declaration should be rewritten. The result of the transformation process of the converter module 318 is the modified one or more Java classes 320. The converter module 318 further implements other data that is provided by the user 304 via the user interface 306. The method in which the converter module 318 analyzes the Java classes and transforms the declarations of list 308 and list 316 to refer to the indicated type parameters, and adds the indicated type parameters to their respective classes and/or methods is discussed in greater detail below.

As described above, type constraints are created for the Java class being transformed and used to infer both formal and actual type parameters for classes and methods. Below, notation and terminology used throughout the patent application is described. The type constraint formalism is extended with substitutions to handle polymorphism. In this patent application, type constraints are used to compute both formal and actual type parameters for classes and methods, as well as the set of declarations that can or must be updated. There are two types of unknowns in the constraint system created: constraint variables and substitutions. The values computed for these unknowns are used to parameterize the program and perform necessary reference updates.

The types of polymorphic variables are not fixed and depend on context. For example, the type of the argument of the method Vector.add is String if the method is invoked on a reference to Vector<String> but it is Integer when invoked on a reference to Vector<Integer>.

The type of a polymorphic variable is composed of a generic type and a substitution (written as α σ where α is the type and σ is the substitution). A substitution is a mapping from type parameters to types. For example, a substitution that maps type parameter T to type String is written as [T:=String] (this notation naturally expands to more than a single mapping) and further type Cell<String> is a composition Cell<T>[T:=String]. The identity substitution is denoted by θ_{id}.

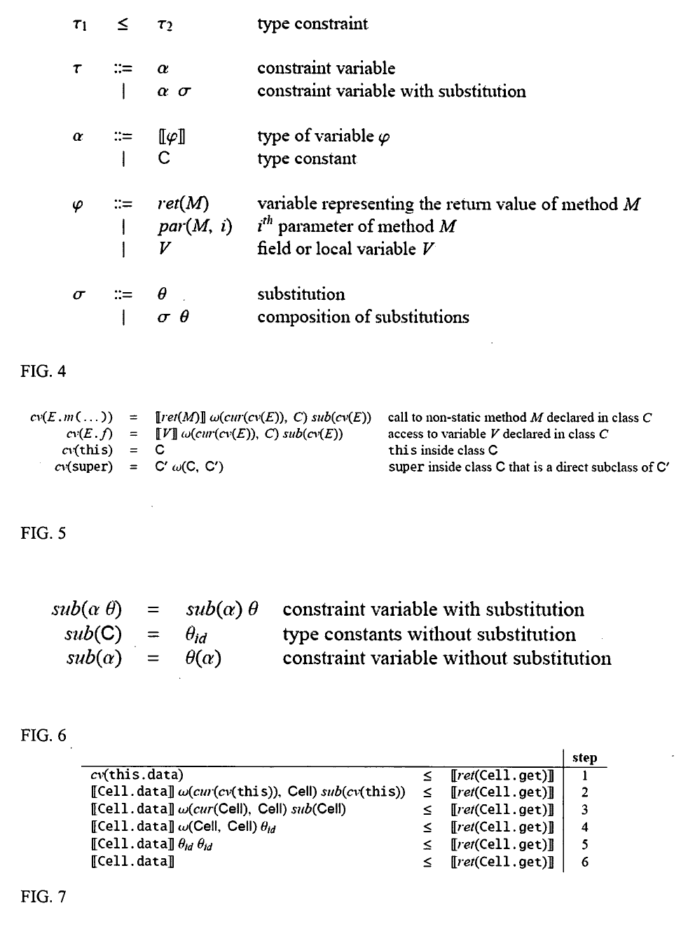

The type constraint grammar presented in FIG. 4 is now discussed. Type constraints describe relationships between types of different entities in a program. Type constraint τ₁≦τ₂ means that τ₁ is equal to or is a subtype of τ₂. ‘Sides’ of a type constraint are called constraint variables. Meta-variable α ranges over constraint variables. A constraint variable may be augmented with a substitution (denoted as σ). A constraint variable may represent the return type of a method, the type of a method parameter, the type of a field or local variable or a type constant. Substitutions may be simple or composed, as shown in the last production of the grammar.

The following section shows how type constraints are created for a given program and illustrates the algorithm on several examples. First, the type, constraint creation rules are presented and then a simple example of constraint creation is presented, which is expanded in to include substitutions and shows what type constraints are created in presence of calls to generic methods.

The rules used to generate type constraints are shown below. The rules used auxiliary functions cv( ) and sub( ), defined below. The function cv( ) is used to create constraint variables for expressions. It is defined as shown in FIG. 5. The auxiliary function sub( ) is used to create substitutions for constraint variables, as shown in FIG. 6. The auxiliary function cur( ) returns, for a given constraint variable, its type in the original program (a type constant, possibly augmented with a substitution). ω(C₁, C₂) denotes a “widening” substitution that describes the widening conversion of generic types. Values calculated for such unknowns are used to parameterize inheritance relations (i.e., extends and implements clauses) in the program.

Constraint generation is described below. To illustrate the simplest case, a constraint is created for the return statement in line 3 of the listing of FIG. 1, duplicated below for convenience:
Object get( ) {return this.data;}

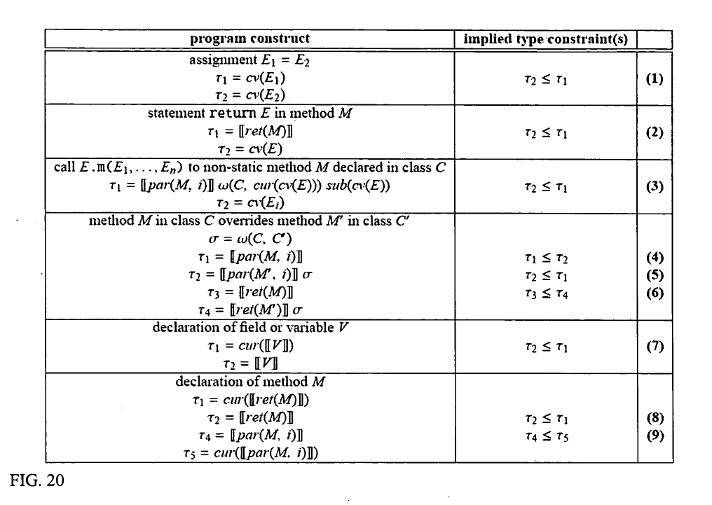

The table of FIG. 7 show the steps in which the resulting constraint [Cell.data]≦[ret(Cell.get)] is created. Type constraints are created according to rules of FIG. 20 below. To show how constraint creation works with substitutions, we use the return statement in line 17 of the listing of FIG. 1 duplicated below for convenience.
Object getFirst( ) {return cell.get( );}

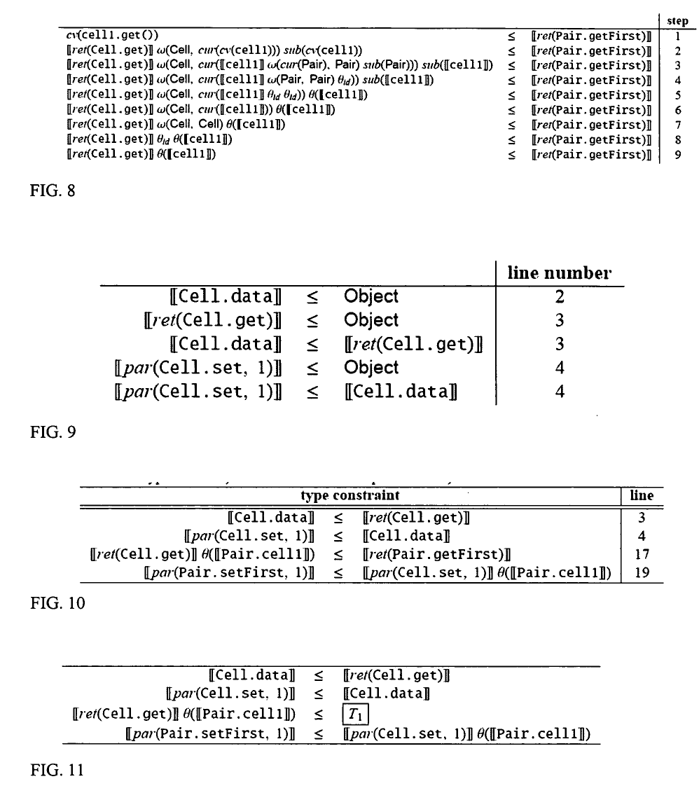

The type constraints with substitutions for line 17 of the listing of FIG. 1 is shown in FIG. 8. An example that illustrates invocations of generic methods is shown in the listing below:

```
class Cell{
  private Object data;
  Object get( ){
    Object x = id(“string”);
    return id(data);
  }
  static <X> X id(X o){ return o; }
}
```

The constraint solving algorithm is discussed in greater detail below. Before presenting an example of the workings of the algorithm is discussed, we show the degrees of freedom exposed and used in the algorithm. Also discussed is how invariant generic sub-typing influences the algorithm, the treatment of raw types, how the decision of which type parameters may be turned into wildcards is made, and the algorithm that handles substitution composition.

The steps of the algorithm are as follows: 1) fresh type parameters are created for the selected constraint variables, 2) fresh type parameters are created for all constraint variables “below” the variables that are already marked as type parameters, 3) a merging heuristic is applied (see below), 4) ‘compound variables’ are simplified by creating new type parameters and assigning values to unknown substitutions and 5) repeat the last three steps until no more simplification or merging is possible. The algorithm terminates because each simplification removes substitutions. Nothing re-introduces them, hence there is a finite number. Each merging step is also finite.

Consider the following example to illustrate some points and degrees of freedom that are encountered when parameterizing classes.

```
class Cell{
  private Object data;
  Object get( ){ return this.data; }
  void set(Object p1){ data = p1; }
  ...
}
```

The constraints for this simple example (where there are no substitutions) are shown in FIG. 9. The listing shows the Cell class and is a fragment of the listing of FIG. 1 duplicated here for convenience. The first choice is about what to turn into a type parameter. Even if it is assumed that a certain type reference should become a type parameter, there are still many possible ways of executing a conversion. For example, assuming that the type of the field data should become a type parameter (named T). The constraint variable [Cell.data] corresponds to that field. Class type parameters in Java can be bounded from below only by other type variables. From the constraint [par(Cell.set, 1)]<[Cell.data] we know that if we are to change [Cell.data] into a type parameter, [par(Cell.set, 1)] also must be changed. We now have the option of using T or a fresh type parameter—this is the first degree of freedom. The two following listings show two translations induced by the alternatives (the upper bound on T is simply read off the type constraint system).

```
class Cell<T extends Object>{
  private T data;
  Object get( ){ return this.data; }
  void set(T p1){ data = p1; }
  ...
}
class Cell<T extends Object, T1 extends T>{
  private T data;
  Object get( ){ return this.data; }
  void set(T1 p1){ data = p1; }
  ...
}
```

Another degree of freedom concerns the placement of type parameters. In the second listing above rather than on the class Cell itself we could declare T1 on the method (thus making the method generic) as shown in the listing below.

```
class Cell<T extends Object>{
  private T data;
  Object get( ){ return this.data; }
  <T1 extends T> void set(T1 p1){ data = p1; }
  ...
}
```

We see then that certain constraint variables must become type parameters once the initial selection has been made. However, there may be others, that may or may not become type parameters. In the example, the result type of the method get could be changed into a type parameter (again, choosing to either “reuse” an existing one or create a fresh one and then choosing to either declare it on the class or on the method). The listing below shows one of these possible parameterizations.

```
class Cell<T extends Number>{
  private T data;
  T get( ){ return this.data; }
  <T1 extends T> void set(T1 p1){ data = p1; }
  ...
}
```

As mentioned before, a type parameter declared on classes cannot have concrete types (i.e. not other type parameters) as lower bounds. The listing below illustrates a case where a concrete lower bound (of type String) makes it impossible to parameterize class HardwiredCell. More precisely, it is not possible to change the type of the field data into a type parameter because it has a concrete lower bound imposed by the initializing assignment. The same concrete type is also a lower bound on the result type of the method get so it also cannot be changed into a type parameter. It would be, however, possible (if not very useful) to change the type of p1 into a type parameter because it has no concrete lower bounds.

```
class HardwiredCell{
  private Object data = “default”;
  Object get( ){ return this.data; }
  void set(Object p1){ data = p1; }
}
```

The code from the listing of FIG. 1 is used to illustrate the parameterization process in the presence of substitutions. The table of FIG. 10 lists the constraints generated from declarations and statements in the listing of FIG. 1 together with the corresponding line numbers. The constraints were straightforwardly generated by using the rules of FIG. 20. The following shows the manner in which these constraints can be used to find a parameterization of the given set of classes (trivial constraints τ≦C, where C is a type constant, are removed from the presentation).

The user selected the return type of the method Pair.getFirst, thus specifying the initial type parameter, T1. The selected type reference corresponds to [ret(Pair.getFirst)]. The solving algorithm is illustrated by in-place replacing constraint variables with their values. Boxes are used to indicate changes in the constraint system. The table of FIG. 11 shows the system after the initial selection.

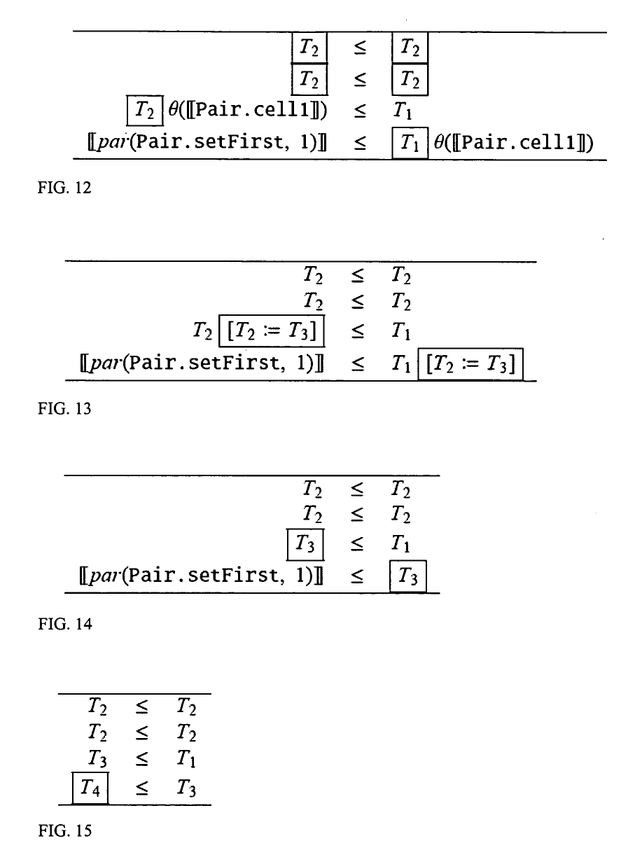

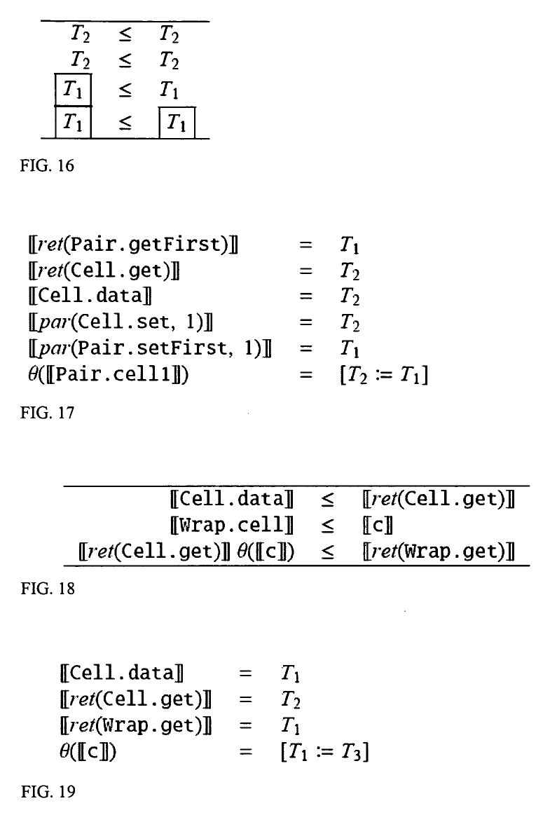

The next step is to give a fresh value to every constraint variable “below” the selected ones. If a constraint variable contains a substitution then the value is given only to the non-substitution part. At the same time, a merging heuristic is employed (i.e., the same value is given to constraint variables, with no substitutions, α₁ and α₂ if α₁≦α₂ and both are constrained from above by the same set of concrete types). Resulting in: [ret(Cell.get)]=[Cell.data]=[par(Cell.set, 1)]=T₂ and the inequalities of FIG. 12. To simplify T₂ θ ([Pair.cell1]), we assign θ([Pair.cell1])=[T₂:=T₃] where T₃ is a fresh variable. This results in the inequalities of FIG. 13, where, after simplifying T₂ [T₂:=T₃] to T₃, the inequalities of FIG. 14 result. FIG. 14 shows that [par(Pair.setFirst, 1)] must be a type parameter too because it is bounded from above by a type parameter, as shown in FIG. 15. Taking the inequalities of FIG. 15 and, after merging one more time (i.e., T₁=T₃=T₄) the inequalities of FIG. 16 result. This produces the end result of FIG. 17, which can be used to translate the source as shown in the listing below:

```
class Cell<T2>{
  private T2 data;
  T2 get( ){ return this.data; }
  void set(T2 p1){ data = p1; }
  ...
}
class Pair<T1>{
  private T1 cell1;
  ...
  T1 getFirst( ){ return cell1.get( ); }
  ...
  void setFirst(T1 p2){ cell1.set(p2); }
  ...
}
```

The manner in which certain type parameters might become a wildcard leading to different parameterizations of the same program is discussed in greater detail below.

With regards to substitution unification, consider the listing below including assignments:

```
class Cell{
  private Object data;
  Object get( ){ return this.data; }
}
class Wrap{
  private Cell cell;
  Object get( ){
    Cell c = cell;
    return c.get( );
  }
}
```

The relevant type constraints generated for the listing above are shown in FIG. 18. After the usual solving, the inequalities of FIG. 18 transform into the equalities of FIG. 19. The above solution is not enough to parameterize the declaration of Wrap.cell. Intuitively, it is seen that the constraint [Wrap.cell]≦[c] implies that θ([Wrap.cell])=θ([c]). Thus, whatever types [Wrap.cell] and [c] have, their parameterizations must be the same because of invariant parametric sub-typing. This assertion is formalized by stating that, for every type constraint α₁θ₁≦α₂θ₂, present are ω(cur(α₁), cur(α₂)) sub(α₁θ₁)=sub(α₂θ₂), are present where cur( ) is a function from constraint variables to types that returns the type of the constraint variable in the original program.

The term ‘invariant subtyping’ relates to the fact that List <Number>≦List<? extends Number> There exists a separate subtyping relation for arguments of parametric types. This results in the following inequalities:
List <Number>≦List<?extends Number>
List <Number>≦List<?super Number>
List <? super Number>≦List<?super Integer>
List <?extends Integer>≦List<?extends Number>

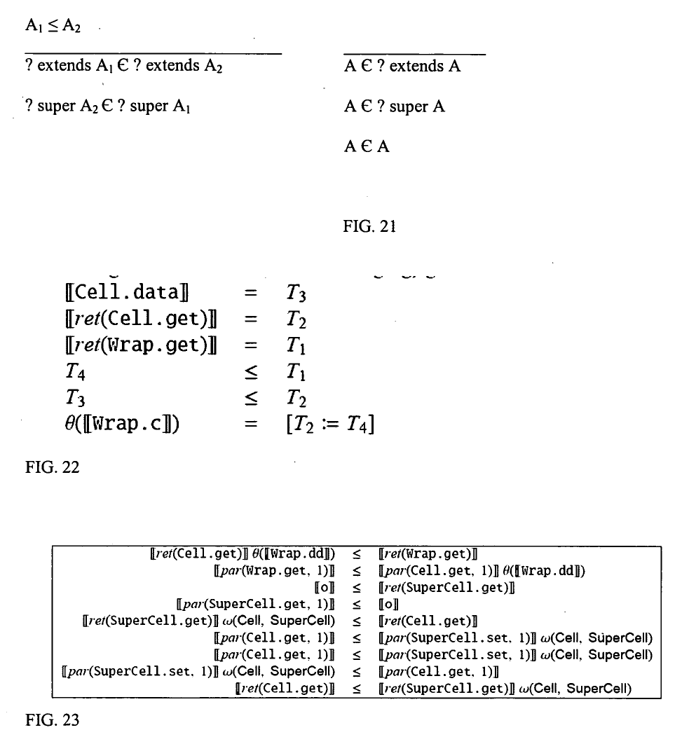

From which it is noticed that, for any parametric type C and any types or wildcards A₁ and A₂ we have that C<A₁>≦C<A₂>iff A₁ ε A₂ where the relation C is defined by the rules of FIG. 21 (it is a partial order on type arguments). Note that in the absence of wildcards the C relation corresponds exactly to invariant sub-typing.

With regards to raw types, consider the following listing:

```
      static Vector foo( ); //external method that we can't modify
class VW {
  Object get( ) { //user selection
    Vector v = Library.foo( );
    return v.get(0);
  }
}
```

The constraints are as follows: [ret(foo)]≦[foo], [ret(Vector.get)] θ[v])≦[ret(VW.get)]. Thus, θ([v])=[E:=T₂] and T₂≦T₁ where E is the type parameter of Vector and the return type of the Vector.get method. The substitution equivalence gives us further that θ([v])=θ([ret(foo)]). However, [ret(foo)] is raw so θ([ret(foo)]) is meaningless (it cannot have a value). Thus, θ ([v]) is meaningless also, as equal to it. Without θ ([v]) we cannot parameterize [ret(VW.get)] so it cannot be done at all.

The manner in which to infer wildcard types is discussed below. Consider the code in the listing below, which is modeled after the well-known method List.addAll(Collection<? extends E>) in class List<E>. The advantage of using the wildcard type there is that a variable of type List<lnteger>is called as an argument to the addAll element when the type of the receiver is List<Number>(which is perfectly type-safe and yet would be disallowed if addAll were declared as List.addAll(Collection<E>). The alternative of declaring an explicit, named type parameter for addAll is semantically equivalent to the wildcard solution but is less preferable because it is syntactically more complex—it introduces a name for an entity that does not need a name.

```
class Cell {
  private Object x;
  void replaceData(Cell other) { x = other.x; }
}
```

The type constraints for this example are: [Cell.x]θ([other])≦[Cell.x]. Assuming that the programmer selected Cell.x as the type parameter (named T₁). Solving the constraints gives: [Cell.x]=T₁ and θ ([other])=[T₁:=T₂], wherein T₂≦T₁. Using the heuristics here would merge T₁ and T₂ (there are no lower bounds on either). In this situation, however, we want to avoid merging, because it would lead to a suboptimal parameterization.

Wildcard type parameters can be discovered as an intermediate step in the algorithm under consideration. To compute the set of type parameters that can become wildcards, the set of those that cannot be become wildcards are subtracted from the set of all type parameters. Informally, a type parameter cannot become a wildcard when either it is bounded from above and below by type parameters, it is bounded from above by a wildcard type parameter, it is bounded from below by a wildcard type parameter, it does not appear in a substitution, it is the type of a constraint variable, it is used more than once or it appears in a context where wildcards are disallowed, e.g., constructor invocations, references to static members or referenced to class literal.

In the example from the listing above, only T₂ can be a wildcard parameter (T₁ is a type of the constraint variable [Cell.x]. The parameterized source is as follows:

```
class Cell<T1> {
  private T1 data;
  void replaceData(Cell<? extends T1> other) { x = other.x; }
}
```

Now considered are the degrees of freedom with respect to wildcards in the following code listing:

```
class Cell {
  private Object data;
  Object get( ) { return this.data; }
}
class Wrap {
  private Cell c;
  Object get( ) { return c.get( ); }
}
```

Solving the constraints without merging results in the equalities and inequalities of FIG. 22. There are at least six parameterizations of these two simple classes, even without considering making methods generic. Not all translations are shown here but are enumerated (all can be easily read off the constraints): 1) T₂ and T₃ may be merged together or remain separate, 2) independently, T₁ and T₄ may be merged together or remain separate, 3) if T₁ and T₄ remain separate, then the choice of whether to turn T₄ into a wildcard is presented (no other type parameter can be turned into a wildcard because only T₄appears in a substitution).

The simple example of the listing below illustrates the constraint creation and solving in the presence of composite substitutions. Assume that the user selected the return type of the Wrap.get method as a type parameter, named T₁.

```
class B { Object x; }
class A {
  B b;
  void set(Object o) { b.x = o; }
}
class C {
  A a;
  Object get( ) { return a.b.x; }
}
```

The relevant type constraints are [B.x]θ([A.b]) θ([C.a])≦[ret(C.get)] and [par(A.set, 1)]≦[B.x]θ([A.b]). We know that [B.x]=T₂ and θ([A.b])θ([Wrap.a])=[T₂:=T₃] where T₃≦T₁ and T₂ and T₃ are fresh type parameters. We find values for the substitutions by creating a fresh type parameter T₄:θ ([A.b])=[T₂:=T₄] and θ([Wrap.a])=[T₄:=T₃]. The remaining step is the creation of a fresh type parameter T₅ for [par(A.set, 1)]. We are required to do so because of the simplified constraint [par(A.set, 1)]≦T₄. Type parameters T₄ and T₃ can become wildcards, which results in the following:

```
class B<T2>{ T2 x; }
class A<T5>{
  B<? super T5> b;
  void set(T5 o) { b.x = o; }
}
class Wrap<T1>{
  A<? extends T1> a;
  T1 get( ) { return a.b.x; }
}
```

Some but not all casts/instanceof using generics are allowed. A downcast from type S to C is allowed only if C is the only subtype of S whose erasure is equal to erasure of C. So cast from List<String> to Vector<String> is proper, because Vector<String> is the only subtype of List<String> whose erasure is equal to Vector. Casting Object to List<String> is not allowed because any List is a subtype of Object, so that is not enough. Consider the following listing:

```
class A {
  Object o;
  Object get( ) {
    Vector v = (Vector)o;
    return v.get(0);
  }
}
```

The constraints are [ret(Vector.get)] θ([v])≦[ret(A.get)] and [(Vector)o)]≦[v]. The second of those constraints induces θ ([(Vector)o])=θ([v]). That means that, when [ret(A.get)] is selected as the type parameter candidate (named T1), the constraints want to change the cast into (Vector<T1>)o. That, however, is unsafe and flagged as such by the compiler.

The listing below shows what type constraints are created in the presence of method overriding. The relevant constraints are shown in the table of FIG. 23. The selected variable is [ret(Wrap.get)].

```
public class Wrap {
  private Cell dd;
  Object get( ) { return dd.get( ); }
  void set(Object o1) { dd.set(o1); }
}
class SuperCell {
  private Object o;
  Object get( ) { return o; }
  void set(Object o2) { o = o2; }
}
class Cell extends SuperCell {
  Object get( ) { return super.get( ); }
  void set(Object o3) { super.set(o3); }
}
```

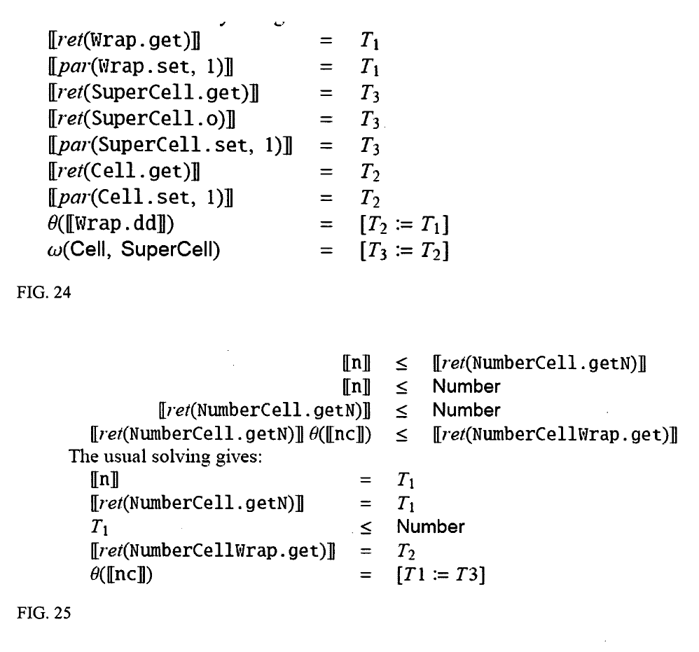

The type constraints are solved and produce the equalities of FIG. 24. The parameterized version of the listing above is shown in the listing below:

```
public class Wrap<T1> {
  private Cell<T1> dd;
  T1 get( ) { return dd.get( ); }
  void set(T1 o1) { dd.set(o1); }
}
class SuperCell<T3>{
  private T3 o;
  T3 get( ) { return o; }
  void set(T3 o2) { o = o2; }
}
class Cell<T2> extends SuperCell<T2>{
  T2 get( ) { return super.get( ); }
  void set(T2 o3) { super.set(o3); }
}
```

With regards to recursively defined classes, consider the listing below:

```
class LinkedList{
  private Object data;
  private LinkedList tail;
  public Object getLast( ) {
    if (tail == null)
      return this.data;
    return tail.getLast( );
  }
}
```

After selecting the return type of LinkedList.getLast, the usual constraint creation and solving, together with the wildcard discovery leads to the following solution:

```
class LinkedList<T1>{
  private T1 data;
  private LinkedList<? extends T1> tail;
  public T1 getLast( ) {
    if (tail == null)
      return this.data;
    return tail.getLast( );
  }
}
```

An interesting test case is shown in the listing below, which shows how the algorithm can deconstruct f-bounds in a simple case.

```
interface Order<T>{
  T less(T t);
}
class Fbound {
  private Order x;
  private Order y;
  Object min( ) {
    return x.less(y);
  }
  void swap( ) {
    Order z = x;
    x = y;
    y = z;
  }
}
```

The result is shown in the listing below:

```
interface Order<T>{
  T less(T t);
}
class Fbound {
  private Order x;
  private Order y;
  Object min( ) {
    return x.less(y);
  }
  void swap( ) {
    Order z = x;
    x = y;
    y = z;
  }
}
```

The class MyVector in the listing below extends a generic class. After the selection has been made, type constraints easily lead to the solution shown in the second listing below:

```
class MyVector extends Vector{
  Object get(int i) { //selection
    return super.get(i);
  }
}
class MyVector<T1> extends Vector<T1>{
  T1 get(int i) {
    return super.get(i);
  }
}
```

The following listing shows an interesting test case involving substitutions and dependencies between type parameters:

```
class NumberCell {
  private Number n;
  Number getN( ) { return n; }
}
class NumberCellWrap {
  private NumberCell nc;
  Object get( ) { return nc.getN( ); }
}
```

The type constraints are shown in FIG. 25. However, the “naive” solution to these constraints is incorrect, because the parametric declaration of nc will only type check if the type argument is a subtype of Number. The solution to this problem is to apply θ([nc]) to both sides of the bounding constraint, i.e., T1<=Number, yielding the constraint T3<=Number. Note, however, that T3<=T2. Now, because a type parameter X can be a subtype of type parameter Y only if Y is the only upper bound on X, T3 and T2 must be equal. But then the erasure of [ret(NumberCellWrap.get)] is Number, so it is changed.

Another example here, where the user selected both [ret(Wrap.get1)] and [ret(Wrap.get2)] is:

```
class Pair<E1, E2 extends E1>{
  E1 getE1( ) { return null;}
  E2 getE2( ) { return null;}
}
class Wrap {
  private Pair p;
  Object get1( ) { return p.getE1( ); }
  Object get2( ) { return p.getE2( ); }
}
```

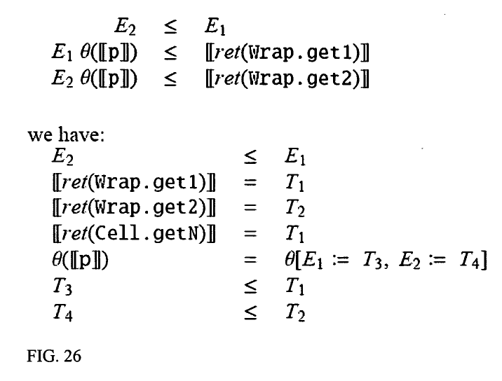

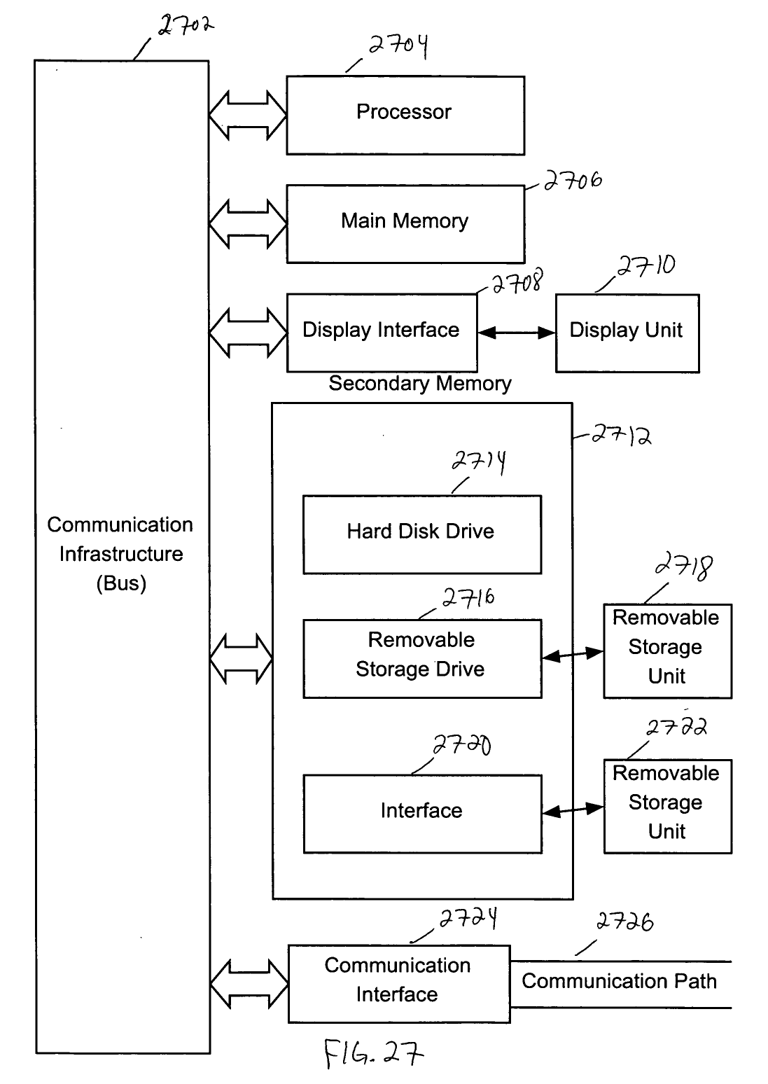

The type constraints are show in FIG. 26. To make the program type check, T₄≦T₃ is also needed. This is garnered by applying θ([p]) to both sides of E₂≦E₁ like this: E₁[T₃:=E_{1,}E₂:=T₄]≦E₁[E₁:=T_{3,}E₂:=T₄]. However, even with this addition, the constraints still possess multiple solutions. Any of the following options could be adopted. Each solution leads to a different parameterization—note that the relation between [ret(Wrap.get1)] and [ret(Wrap.get2)] can be anything except what it is in the original program (i.e. none). the options are: 1) T₁=T₂=T₃=T₄ (probably the best solution, if somewhat unsatisfying, and easy to achieve given the merging heuristic), 2) T₁=T₃=T₄ and T₁≦T₂ and 3) T₁=T₃, T₂=T₄ and T₂≦T₁.

It has been asserted that since public instance variables can be directly accessed and modified by any class, formal generic parameters cannot be used as their type. There are in fact several ways to handle this issue. The following code is considered:

```
class OpenCell<T>{
  public T data;
}
class Client {
  void example( ) {
    OpenCell c= new OpenCell( );
    c.data = new Integer (1);
    callOutside(c);
    Integer i = (Integer) c.data;
  }
}
```

Converting to the following preserves behavior:

```
class Client {
  void example( ) {
    OpenCell<Integer> c= new OpenCell<Integer>( );
    c.data = new Integer (1);
    callOutside(c);
    Integer i = c.data;
  }
}
```

In particular, if the method callOutside were to assign some non-Integer value to c.data by means of a raw reference, the subsequent (implicit) cast to Integer by Client would fail with a ClassCastException. However, such an exception would have been thrown by the original program, so behavior has been preserved.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 27 is a high level block diagram showing an information processing system useful for implementing one embodiment of the present invention. The computer system includes one or more processors, such as processor 2704. The processor 2704 is connected to a communication infrastructure 2702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 2708 that forwards graphics, text, and other data from the communication infrastructure 2702 (or from a frame buffer not shown) for display on the display unit 2710. The computer system also includes a main memory 2706, preferably random access memory (RAM), and may also include a secondary memory 2712. The secondary memory 2712 may include, for example, a hard disk drive 2714 and/or a removable storage drive 2716, representing a floppy disk drive, a magnetic tape drive, an optical disk drive, etc. The removable storage drive 2716 reads from and/or writes to a removable storage unit 2718 in a manner well known to those having ordinary skill in the art. Removable storage unit 2718, represents a floppy disk, a compact disc, magnetic tape, optical disk, etc. which is read by and written to by removable storage drive 2716. As will be appreciated, the removable storage unit 2718 includes a computer readable medium having stored therein computer software and/or data.

In alternative embodiments, the secondary memory 2712 may include other similar means for allowing computer programs or other instructions to be loaded into the computer system. Such means may include, for example, a removable storage unit 2722 and an interface 2720. Examples of such may include a program cartridge and cartridge interface (such as that found in video game devices), a removable memory chip (such as an EPROM, or PROM) and associated socket, and other removable storage units 2722 and interfaces 2720 which allow software and data to be transferred from the removable storage unit 2722 to the computer system.

The computer system may also include a communications interface 2724. Communications interface 2724 allows software and data to be transferred between the computer system and external devices. Examples of communications interface 2724 may include a modem, a network interface (such as an Ethernet card), a communications port, a PCMCIA slot and card, etc. Software and data transferred via communications interface 2724 are in the form of signals which may be, for example, electronic, electromagnetic, optical, or other signals capable of being received by communications interface 2724. These signals are provided to communications interface 2724 via a communications path (i.e., channel) 2726. This channel 2726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 2706 and secondary memory 2712, removable storage drive 2716, a hard disk installed in hard disk drive 2714, and signals. These computer program products are means for providing software to the computer system. The computer readable medium allows the computer system to read data, instructions, messages or message packets, and other computer readable information from the computer readable medium.

Computer programs (also called computer control logic) are stored in main memory 2706 and/or secondary memory 2712. Computer programs may also be received via communications interface 2724. Such computer programs, when executed, enable the computer system to perform the features of the present invention as discussed herein. In particular, the computer programs, when executed, enable the processor 2704 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Therefore, while there has been described what is presently considered to be the preferred embodiment, it will be understood by those skilled in the art that other modifications can be made within the spirit of the invention.

What is claimed is:

1. A method for transforming at least a portion of at least one programming structure into a type parameter, the method comprising:
receiving a first list of at least one declaration of at least one programming structure for transforming to a type parameter;
generating a second list of at least one declaration of the at least one programming structure that must be transformed into a type parameter if the at least one declaration of the first list is transformed to a type parameter;
generating a third list of at least one declaration of the at least one programming structure that may optionally be transformed into a type parameter; and
receiving a selection of zero or more declarations from the second list and zero or more declarations from the third list.

2. The method of claim 1, the method further comprising:
modifying the at least one programming structure to transform into a type parameter the selection of zero or more declarations from the second list and zero or more declarations from the third list.

3. The method of claim 2, wherein the receiving a first list comprises:
receiving from a user a first list of at least one declaration of at least one programming structure for transforming to a type parameter, wherein a declaration comprises any one of a method parameter, a method return type, a local variable or a field.

4. The method of claim 1, the method further comprising:
receiving a name for each selection of zero or more declarations from the second list and zero or more declarations from the third list; and
modifying the at least one programming structure to transform into a type parameter the selection of zero or more declarations from the second list and zero or more declarations from the third list, wherein each type parameter is named according to the name received for the selection.

5. The method of claim 4, wherein the receiving a name comprises:
receiving from a user a name for each selection of zero or more declarations from the second list and zero or more declarations from the third list.

6. The method of claim 1, the method further comprising:
receiving a location for each selection of zero or more declarations from the second list and zero or more declarations from the third list; and
modifying the at least one programming structure to transform into a type parameter the selection of zero or more declarations from the second list and zero or more declarations from the third list, wherein each type parameter is located according to the location received for the selection.

7. The method of claim 6, wherein the receiving a location comprises:
receiving from a user a location for each selection of zero or more declarations from the second list and zero or more declarations from the third list.

8. An information processing system for transforming at least a portion of at least one programming structure into a type parameter, comprising:
a receiver for receiving a first list of at least one declaration of at least one programming structure for transforming to a type parameter;
a processor configured for:
generating a second list of at least one declaration of the at least one programming structure that must be transformed into a type parameter if the at least one declaration of the first list is transformed to a type parameter;
generating a third list of at least one declaration of the at least one programming structure that may optionally be transformed into a type parameter; and
an interface for receiving a selection of zero or more declarations from the second list and zero or more declarations from the third list.

9. The information processing system of claim 8, the processor further configured for:
modifying the at least one programming structure to transform into a type parameter the selection of zero or more declarations from the second list and zero or more declarations from the third list.

10. The information processing system of claim 8, further comprising:
an interface for receiving from a user a first list of at least one declaration of at least one programming structure for transforming to a type parameter, wherein a declaration comprises any one of method parameter, a method return type, a local variable or a field.

11. The information processing system of claim 8, wherein the interface comprises:
an interface for receiving a selection of zero or more declarations from the second list and zero or more declarations from the third list and for receiving a name for each selection of zero or more declarations from the second list and zero or more declarations from the third list; and
wherein the processor is further configured for modifying the at least one programming structure to transform into a type parameter the selection of zero or more declarations from the second list and zero or more declarations from the third list, wherein each type parameter is named according to the name received for the selection.

12. The information processing system of claim 11, wherein the interface comprises:
an interface for receiving from a user a selection of zero or more declarations from the second list and zero or more declarations from the third list and for receiving a name for each selection of zero or more declarations from the second list and zero or more declarations from the third list.

13. The information processing system of claim 8, wherein the interface comprises:
an interface for receiving a selection of zero or more declarations from the second list and zero or more declarations from the third list and for receiving a location for each selection of zero or more declarations from the second list and zero or more declarations from the third list; and
wherein the processor is further configured for modifying the at least one programming structure to transform into a type parameter the selection of zero or more declarations from the second list and zero or more declarations from the third list, wherein each type parameter is located according to the location received for the selection.

14. The information processing system of claim 13, wherein the interface comprises:
an interface for receiving from a user a selection of zero or more declarations from the second list and zero or more declarations from the third list and for receiving a location for each selection of zero or more declarations from the second list and zero or more declarations from the third list.

15. A computer readable medium including computer instructions for transforming at least a portion of at least one programming structure into a type parameter, the computer instructions including instructions for:
receiving a first list of at least one declaration of at least one programming structure for transforming to a type parameter;
generating a second list of at least one declaration of the at least one programming structure that must be transformed into a type parameter if the at least one declaration of the first list is transformed to a type parameter;
generating a third list of at least one declaration of the at least one programming structure that may optionally be transformed into a type parameter; and
receiving a selection of zero or more declarations from the second list and zero or more declarations from the third list.

16. The computer readable medium of claim 15, further comprising instructions for:
modifying the at least one programming structure to transform into a type parameter the selection of zero or more declarations from the second list and zero or more declarations from the third list.

17. The computer readable medium of claim 16, wherein the instructions for receiving a first list comprise:
receiving from a user interface a first list of at least one declaration of at least one programming structure for transforming to a type parameter, wherein a declaration comprises any one of a method parameter, a method return type, a local variable or a field.

18. The computer readable medium of claim 15, further comprising instructions for:
receiving a name for each selection of zero or more declarations from the second list and zero or more declarations from the third list; and
modifying the at least one programming structure to transform into a type parameter the selection of zero or more declarations from the second list and zero or more declarations from the third list, wherein each type parameter is named according to the name received for the selection.

19. The computer readable medium of claim 18, wherein the instructions for receiving a name comprise:
receiving from a user interface a name for each selection of zero or more declarations from the second list and zero or more declarations from the third list.

20. The computer readable medium of claim 15, further comprising instructions for:
receiving a location for each selection of zero or more declarations from the second list and zero or more declarations from the third list; and
modifying the at least one programming structure to transform into a type parameter the selection of zero or more declarations from the second list and zero or more declarations from the third list, wherein each type parameter is located according to the location received for the selection.
